(19) United States
(12) Patent Application Publication
(10) Pub. No.: US 2002/0101888 A1
(43) Pub. Date: Aug. 1, 2002

(54) Method and system for controlling the flow of data in a base transceiver station

(76) Inventors: Steven W. Keck, Mountain View, CA (US); Martin R. Raumann, Lodi, CA (US)

Correspondence Address: Patent Department, Iospan Wireless, P.O. Box 641867, San Jose, CA, 95164-1867, US

(21) Appl. No.: 09/775,860

(22) Filed: Feb. 1, 2001

(51) Int. Cl. H04J 1/16

(52) U.S. Cl. 370/537; 370/235; 370/329

(57) ABSTRACT

A first embodiment of the present invention includes a method for controlling the flow of data in a base transceiver station. The method includes providing first and second upstream devices, providing a downstream device and enabling simultaneous communication between the downstream device and the first and second upstream devices. A second embodiment of the present invention includes a wireless communication system. The wireless communication system includes at least one subscriber unit and at least one base transceiver station, the base transceiver station transmitting and receiving signals to and from the at least one subscriber unit. The at least one base transceiver station includes a first upstream device, a second upstream device coupled to the first upstream device and a downstream device coupled to the first and second upstream devices wherein the downstream device includes means for enabling simultaneous communication between the downstream device and the first and second upstream devices. A third embodiment of the present invention includes a base transceiver station that includes a first upstream device, a second upstream device and a downstream device coupled to the first and second upstream devices wherein simultaneous communication between the downstream device and the first and second upstream devices is enabled.

### FIELD OF THE INVENTION

This invention relates generally to wireless communications. More particularly the invention relates to a method and system for controlling the flow of data in a base transceiver station.

### BACKGROUND OF THE INVENTION

Wireless communication systems typically use radio frequency (RF) signals to wirelessly transmit modulated data from a central source (for example, a base transceiver station (BTS)) to one or more remote devices (for example, subscriber units) within an area or region.

FIG. 1 shows a conventional wireless communication system 100. The system 100 includes a BTS 110 and subscriber units 120, 130. Contained within the BTS 110, but not shown in FIG. 1, is an equipment rack which houses a channel assembly.

For a more detailed description of the channel assembly, please refer now to FIG. 2A. FIG. 2A is an illustration of a channel assembly 200. The channel assembly 200 includes two BTS managers 210, 220, and a plurality of channel modules 230.

Each BTS manager 210, 220 is responsible for controlling the flow of all data traffic into and out of a BTS. It provides a common backhaul data interface for the BTS and functions as the logical center for all BTS data traffic. In addition, each manager 210, 220 is responsible for controlling, configuring, and monitoring the health and status of all elements within the BTS.

Each of the plurality of channel modules 230 is responsible for implementing the wireless communication interface between the BTS and subscriber units for a given radio frequency (RF) channel. This includes (but is not limited to) data path processing, air interface media access control (MAC), physical layer (PHY) modulation/demodulation, and RF signal manipulation.

For a better understanding of the conventional BTS please refer to FIG. 2B. FIG. 2B is an illustration of the architectural configuration of the channel assembly components. Here, both BTS managers 210, 220 are coupled to each of the plurality of channel modules 230. For the purposes of this patent application, an upstream device is defined as a central switching device coupled to a network such as the Internet and a downstream device is defined as a device that facilitates communication between an upstream device and an end user (i.e. a subscriber unit). Accordingly, each BTS manager 210, 220 is characterized as an upstream device whereas each of the plurality of channel modules 230 is characterized as a downstream device.

In a conventional implementation, a single active data path 240 is available for communication between the upstream devices and the downstream devices. That is to say that only one upstream device at a time is active for data-path communication between each of the plurality of downstream devices. A single path approach is typically utilized because such an approach is inexpensive and doesn't require the use of complex circuitry. However, since only one upstream device can be active at a time, communications with the inactive upstream device is disabled. Consequently, the flow control functionality related to the data-path communication is enabled only for the active upstream device.

Because the inactive manager is prevented from communicating directly with the plurality of channel modules, the higher-level management elements within the disabled manager are unable to directly monitor the channel modules. Furthermore, since each channel module cannot simultaneously send or receive data to and from both managers at the same time, the base transceiver station is unable to implement two active parallel data paths. Consequently, fault recovery times are increased due to the time necessary to switch the data path 240 from the active manager to the inactive manager if the active manager fails. This switch over time increases the likelihood of data loss in the event of a failure.

Accordingly, what is needed is a more effective method and system for controlling the flow of data in a BTS. The method and system should be simple, cost effective and capable of being easily adapted to existing technology. The present invention addresses such a need.

### SUMMARY OF THE INVENTION

The present invention includes a method and system for controlling the flow of data in a base transceiver station. The method and system allow for the activation of multiple independent data paths thereby enabling simultaneous communication between multiple upstream devices and downstream devices in a wireless communication system. By enabling simultaneous communication between multiple upstream devices and downstream devices, more flexibility is added to the management capabilities of the wireless communication system and fault recovery is accomplished in a faster and more efficient manner.

A first embodiment of the present invention includes a method for controlling the flow of data in a base transceiver station. The method includes providing first and second upstream devices, providing a downstream device and enabling simultaneous communication between the downstream device and the first and second upstream devices.

A second embodiment of the present invention includes a wireless communication system. The wireless communication system includes at least one subscriber unit and at least one base transceiver station, the at least one base transceiver station transmitting and receiving signals to and from the at least one subscriber unit. The at least one base transceiver station includes a first upstream device, a second upstream device coupled to the first upstream device and a downstream device coupled to the first and second upstream devices wherein the downstream device includes means for enabling simultaneous communication between the downstream device and the first and second upstream devices.

A third embodiment of the present invention includes a base transceiver station that includes a first upstream device, a second upstream device and a downstream device coupled to the first and second upstream devices wherein simultaneous communication between the downstream device and the first and second upstream devices is enabled.

A fourth embodiment of the present invention includes a data frame structure for use in a base transceiver station, the base transceiver station including a first upstream device, a second upstream device and a downstream device. The data frame structure includes a frame sync portion, a provisioning information portion, a control portion, and a payload portion wherein the data frame structure facilitates simultaneous communication between the downstream device and the first and second upstream devices.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 shows a conventional wireless communication system.

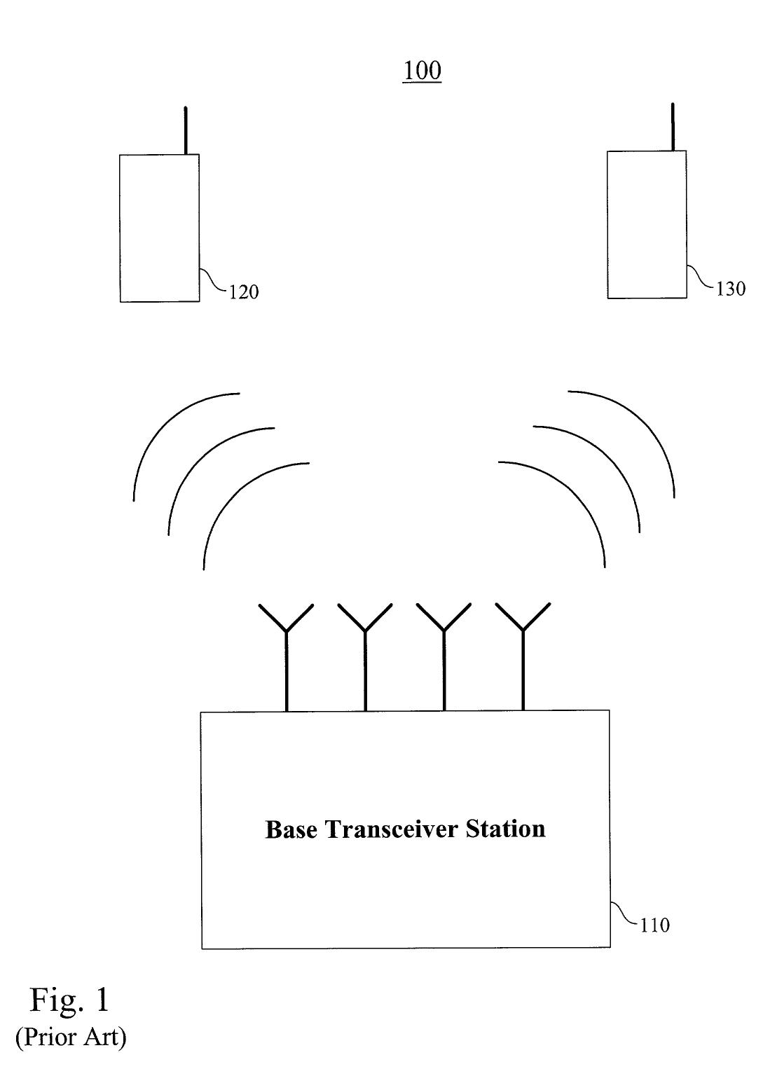

FIG. 2A is an illustration of the channel assembly.

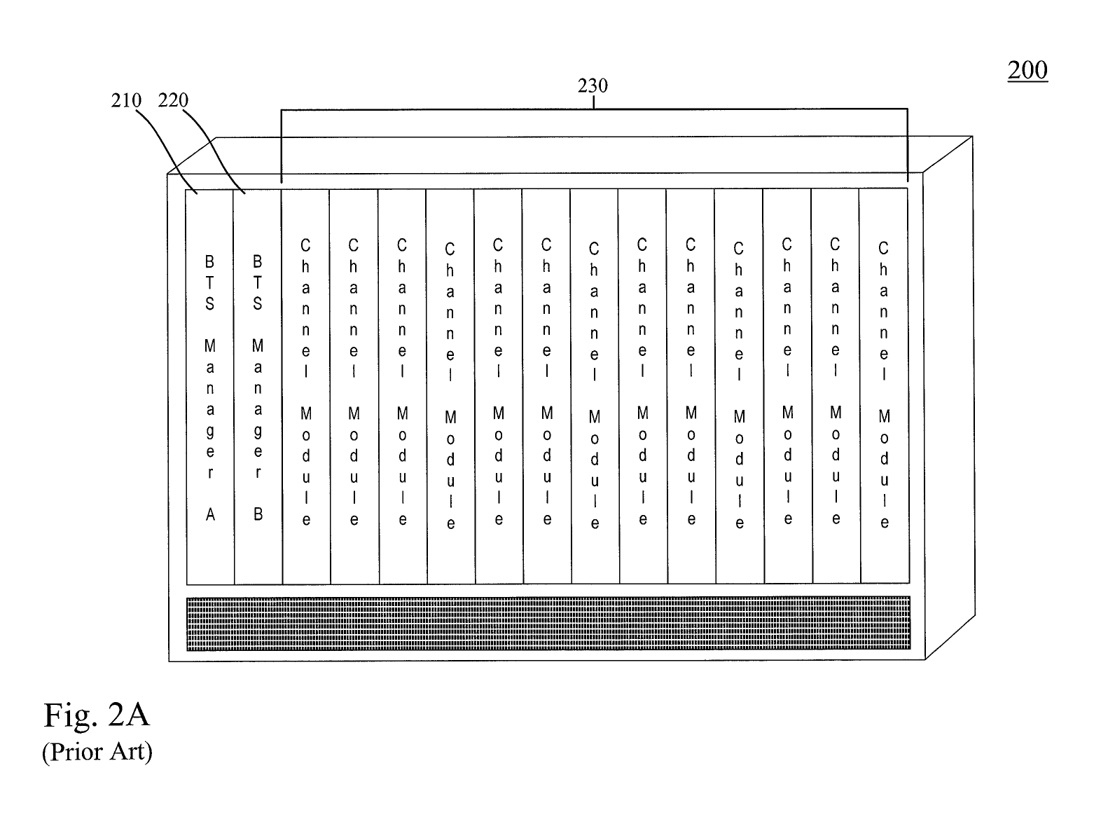

FIG. 2B is a more detailed illustration of the channel assembly.

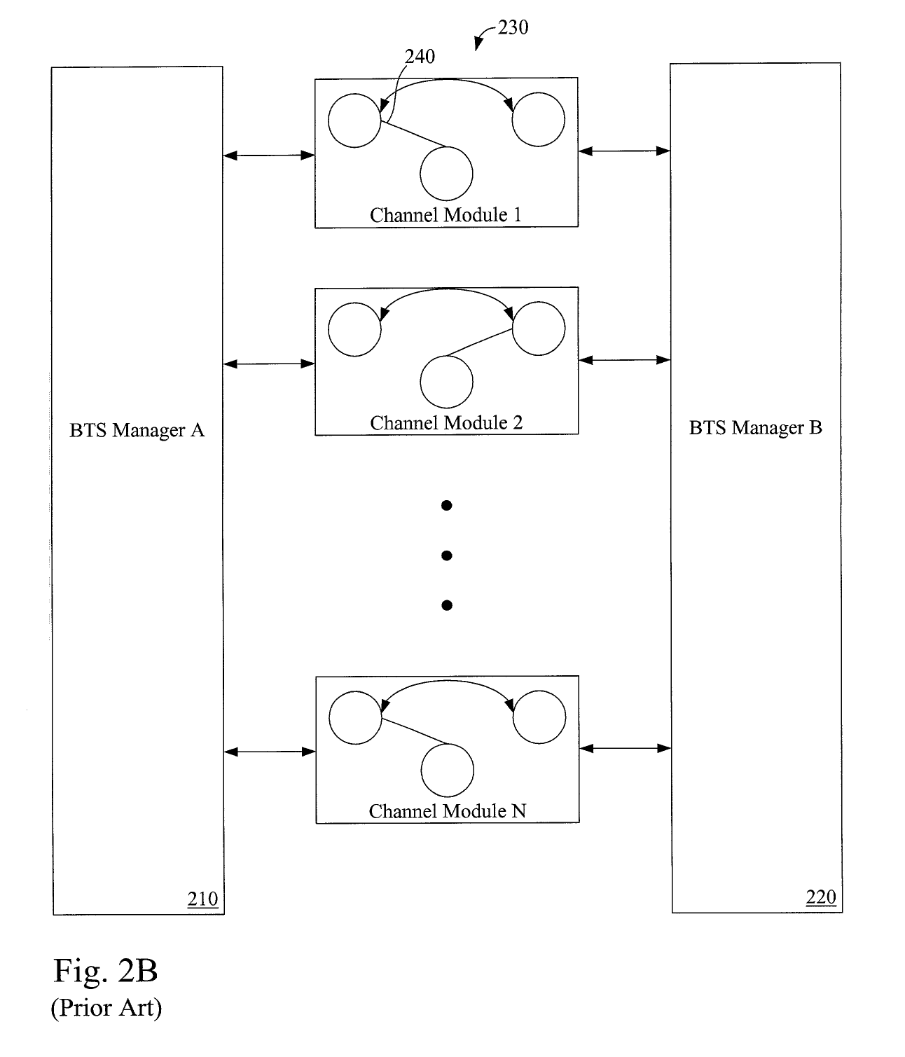

FIG. 3 shows a flowchart of the method in accordance with the present invention.

FIG. 4 is an illustration of a system in accordance with the present invention.

FIG. 5 is an illustration of a channel module in accordance with the present invention.

FIG. 6 is an illustration of the backplane interface logic of the channel module in accordance with the present invention.

FIG. 7 shows the backplane frame configuration in accordance with the present invention.

### DETAILED DESCRIPTION OF THE INVENTION

The present invention relates to a method and system for controlling the flow of data in a base transceiver station. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention includes a method and system for controlling the flow of data in a wireless communication environment. The method and system allow for simultaneous communication between multiple upstream devices and downstream devices in a wireless communication system. By allowing simultaneous communication between upstream and downstream devices, more flexibility is added to the management capabilities of the wireless communication system and fault recovery is accomplished in a faster and more efficient manner.

As previously described, the invention includes wireless communication between at least one base transceiver station and subscriber units. The communication is two-way. That is, information is transmitted from the base transceiver station to the subscriber units (down link transmission), and information is transmitted from the subscriber units to the base transceiver station (up link transmission).

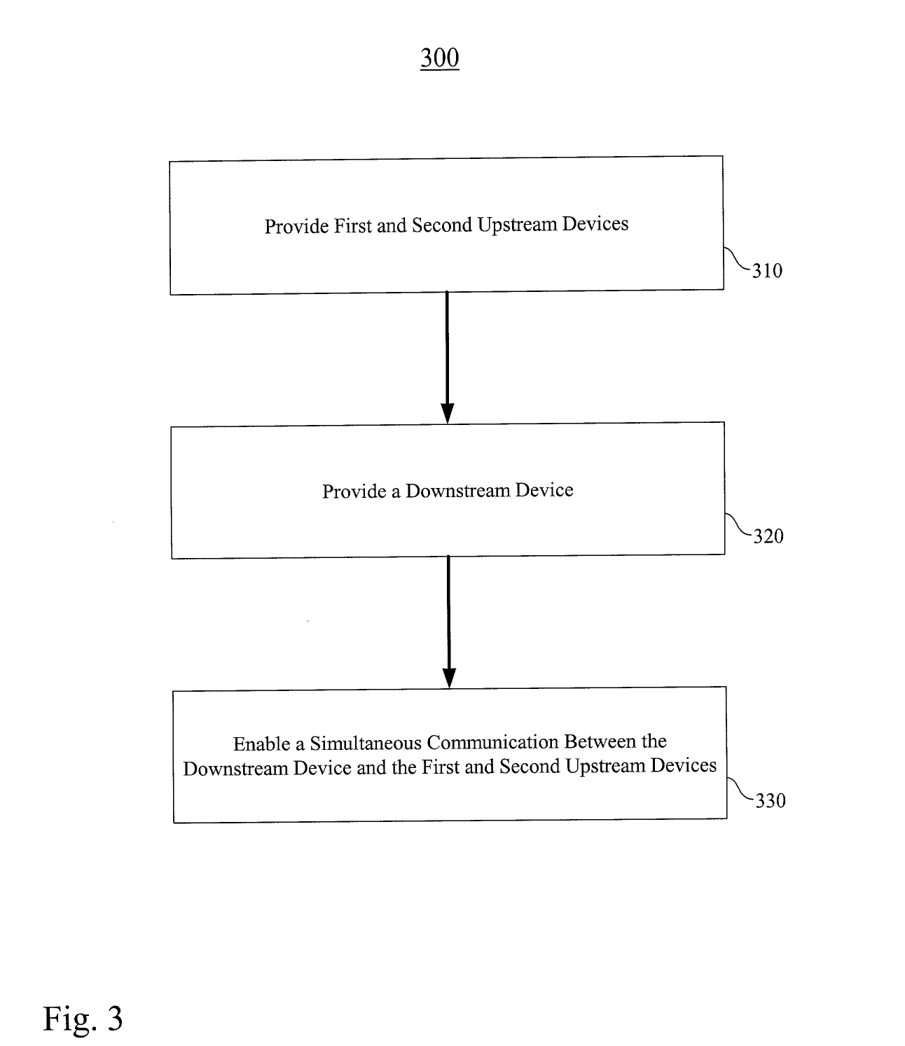

For a further understanding of the method in accordance with the present invention, please refer now to FIG. 3. FIG. 3 is a flowchart 300 of the method in accordance with the present invention. Initially, first and second upstream devices are provided via step 310. Preferably, the upstream devices comprise BTS managers. Next, a downstream device is provided, via step 320. Preferably, the downstream device comprises a channel assembly channel module. Finally, a simultaneous communication between the downstream device and the first and second upstream devices is enabled, via step 330.

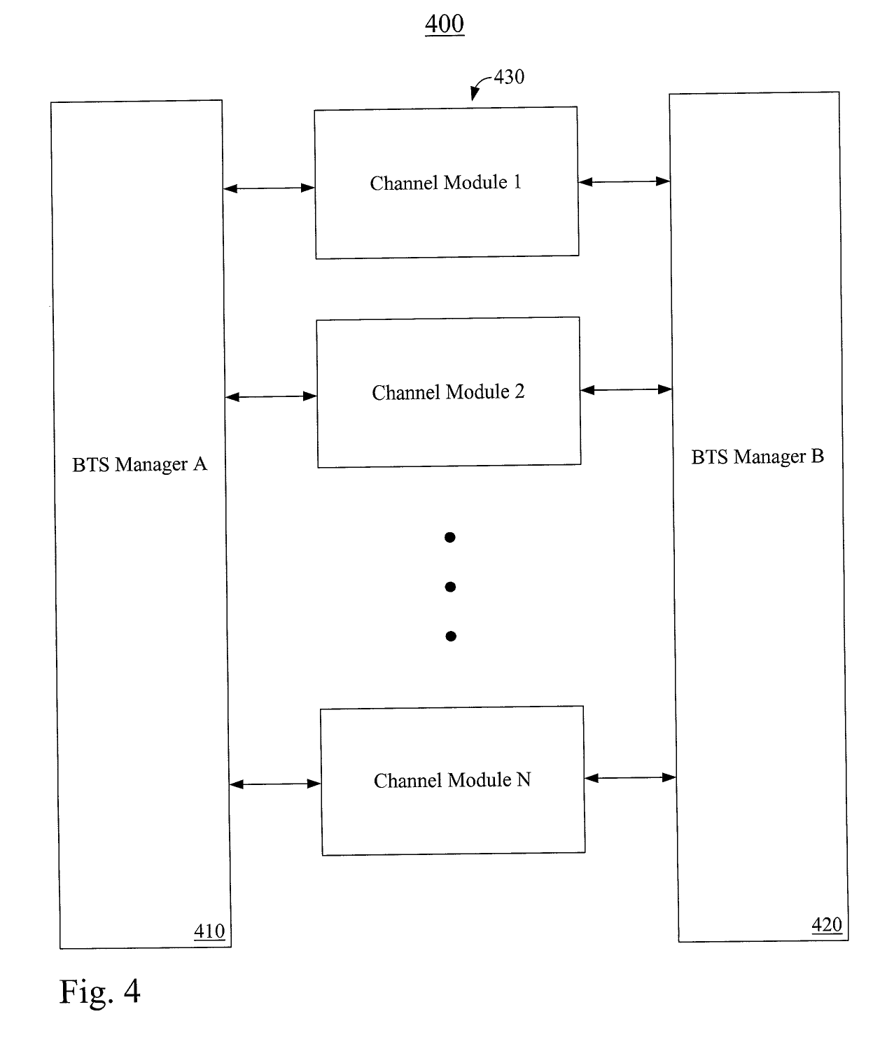

For a better understanding of a system in accordance with the present invention please refer now to FIG. 4. FIG. 4 is an illustration of the system 400 in accordance with the present invention. The system 400 in accordance with the present invention comprises two BTS managers 410, 420 and a plurality of channel modules 430. However, unlike the prior art system, the system 400 in accordance with the present invention allows for simultaneous communication between the two BTS managers 410, 420 and each of the plurality of channel modules 430.

The BTS managers 410, 420 sit atop the hierarchical configuration and are responsible for managing all traffic into and out of the BTS. In addition, each BTS manager 410, 420 monitors all health, status, and statistics for all sub-components within the BTS. Two managers are implemented for redundancy purposes in the event that one of the managers unexpectedly fails.

Channel Module

As previously stated, the channel module is responsible for implementing the wireless communication interface for a given radio frequency channel. This includes data path processing, air interface media access control (MAC), physical layer (PHY) modulation/demodulation, and radio frequency signal manipulation.

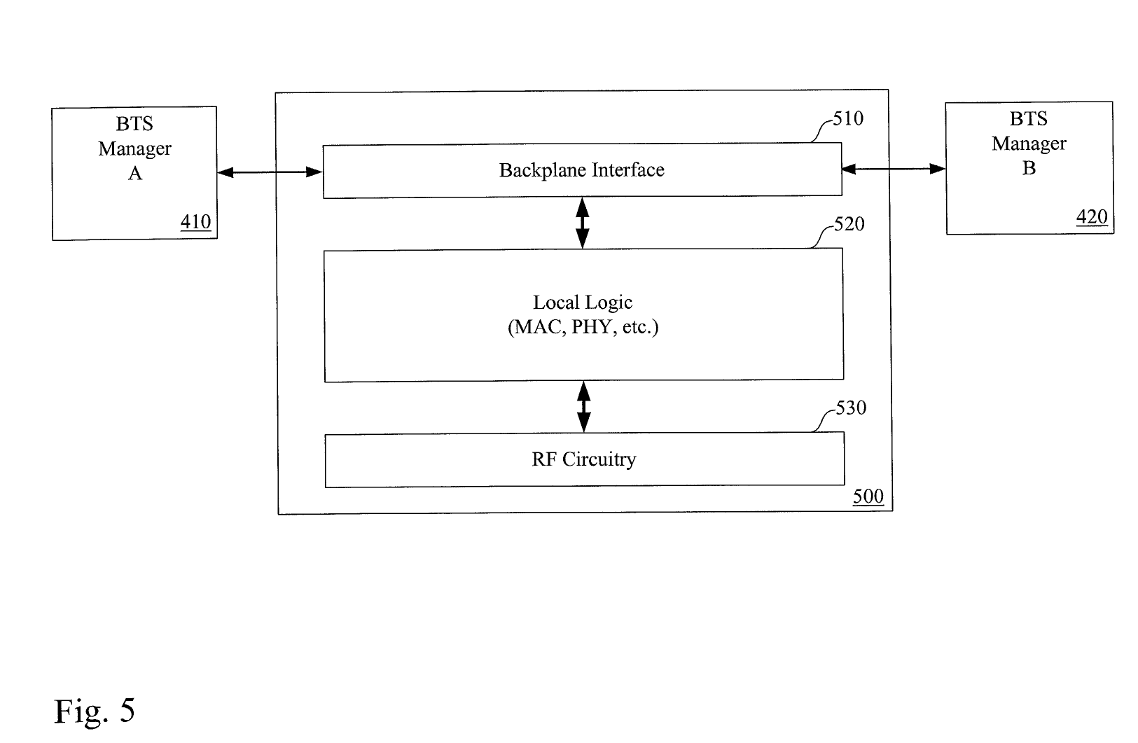

For a more detailed description of a channel module, please refer to FIG. 5. FIG. 5 is a more detailed illustration of the logical makeup of a channel module 500 in accordance with the present invention. Each channel module 500 comprises a backplane interface 510, local logic 520 (MAC, PHY, etc.), and Radio Frequency (RF) circuitry 530 wherein the backplane interface 510 is coupled to the local logic 520 and the BTS managers 410, 420 (the BTS managers being previously shown in FIG. 4).

Backplane Interface

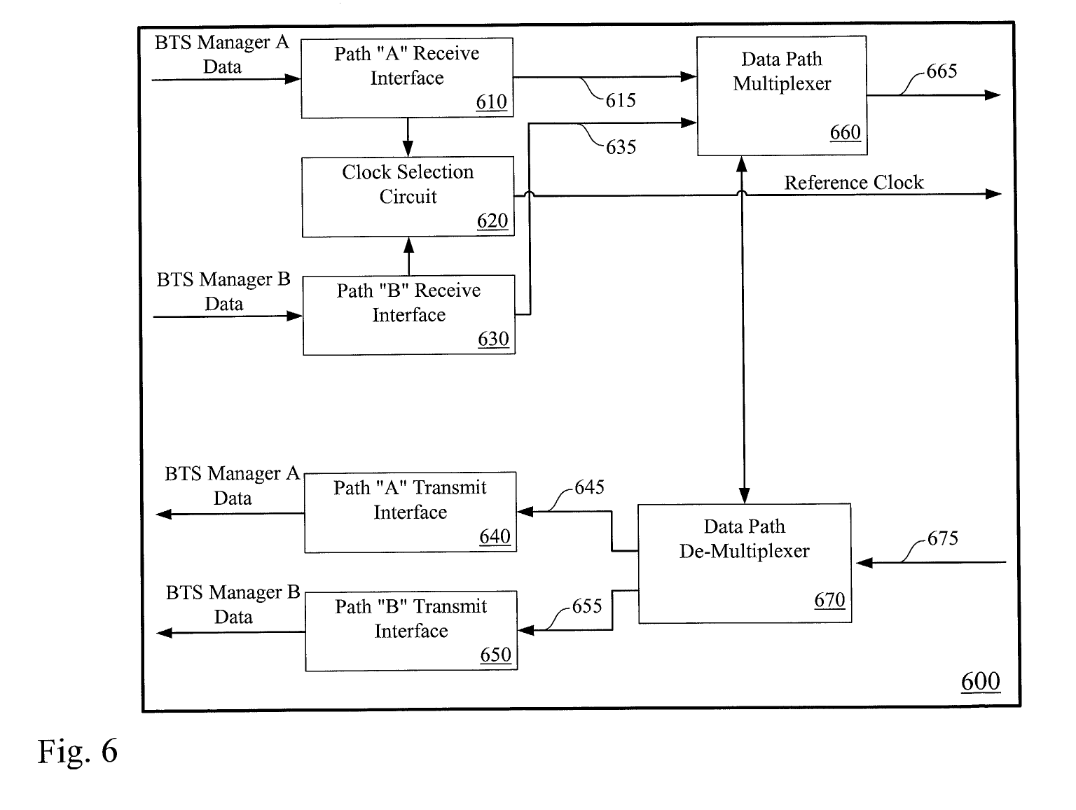

For a more detailed description of a backplane interface, please refer to FIG. 6. FIG. 6 is detailed illustration of a backplane interface 600 in accordance with the present invention. The backplane interface 600 comprises two path receive interfaces 610, 630, a clock reference selection circuit 620, two path transmit interfaces 640, 650, a data path multiplexor 660, and a data path de-multiplexor 670.

Both path receive interfaces 610, 630 are coupled to the clock selection circuit 620 and the data path multiplexor 660. The data path multiplexor 660 and the clock reference selection circuit 620 are further coupled to the local logic.

The clock reference selection circuit 620 comprises a hardware circuit that independently monitors the state of a clock reference within each of the BTS managers. The data path multiplexer 660 receives separate independent data streams 615, 635 from each of the BTS managers via the two path receive interfaces 610, 630 and generates a single data stream 665 to be sent to the local logic. The data path de-multiplexor 670 receives a single stream of data 675 from the local logic and generates separate data streams 645, 655 to be transmitted to the BTS managers via the two path transmit interfaces 640, 650.

In accordance with the present invention, simultaneous communication is enabled between both BTS managers and each channel module. Because a simultaneous, bi-directional flow of data is enabled between both BTS managers and each channel module, higher level management elements within both managers are able to simultaneously monitor each channel module. This adds more flexibility the management capabilities of the wireless communication system.

Fault Recovery

Fault recovery involves transitioning between BTS managers in the event of a manager failure. There are two elements of fault recovery in regards to the coupling of BTS managers and a given channel module: data path transitioning and clock reference transitioning.

The first element of fault recovery relates to the two independent data paths that exist between a given channel module and each BTS manager. These independent data paths are simultaneously active and enable concurrent communications between each BTS manager and each channel module. Accordingly, since both BTS managers can simultaneously communicate with each channel module, no switchover is required in the event of a failure of one of the BTS managers. Conventional implementations, by contrast, can support only one active data path connection between a BTS manager and a channel module. As a result, in the event of a BTS manager failure, conventional implementations must disable the path to the failed manager and activate the path to the alternate manager. Consequently, data could be potentially lost during the time it takes to disable the path to the failed manager and activate the path to the alternate manager. The present invention minimizes this potential loss of data by eliminating the time it takes to disable the path to the failed manager and activate the path to the alternate manager.

The second element of fault recovery relates to clock reference selection. Other wireless circuits (such as the media access control (MAC), physical layer interface (PHY), etc.) within a base station channel module operate using a single clock reference. The performance of the wireless interface is directly related to the stability of this clock reference. Since either BTS manager can serve as a clock reference source, each channel module has a clock selection circuit 620 to “choose” between the two references.

In addition, the clock selection circuit 620 simultaneously monitors the health of each clock from each manager. This permits an immediate transition between clock references in the event of a failure. This transition is independent of the state of the dual data paths. Since the present invention's channel module has a simultaneous connection to both BTS managers, no time is wasted in disabling one manager and activating another. Current implementations must first perform a data path switchover before a new clock reference can be established. Consequently, this additional switchover time increases the potential for data loss in current implementations.

Data Structure

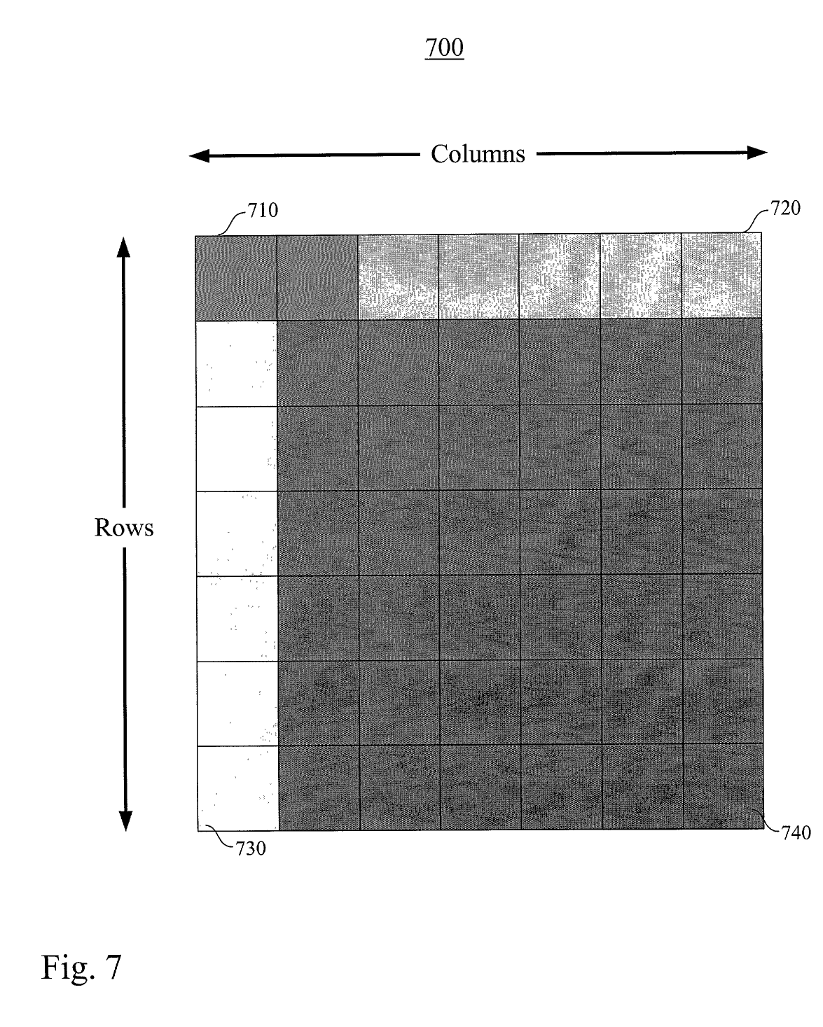

The BTS manager/channel module backplane interface in accordance with the present invention uses a logical frame data structure to delineate messages sent between the two devices and effectuate the simultaneous communication between both BTS Managers and each channel module. Accordingly, bytes of data are sent via a “backplane frame” structure in a pre-determined sequence. For a better understanding of the “backplane frame” please refer to FIG. 7. FIG. 7 shows the backplane frame configuration 700 in accordance with the present invention. The configuration 700 includes frame sync blocks 710, provisioning information blocks 720, control blocks 730, and payload blocks 740.

The backplane frame configuration 700 is organized in a table form and each block represents a byte of information. Preferably the table is seven columns wide by ten rows tall for a total of 70 bytes of information. The top-left byte is designated Row 0, Column 0 (byte 0,0) and the bottom-right byte is designated Row 9, Column 6 (byte 9,6).

The left-most bit is bit 7 (the most significant) and the right-most bit is bit 0 (the least significant bit).

The frame sync blocks 710 comprise a fixed pattern used for bit and frame boundary synchronization. The receiver reads these blocks to attain the fixed pattern and then synchronizes the pattern with the transmitter. The last five columns of Row 0 are the provisioning information blocks 720. These blocks are reserved for hard provisioning information such as shelf number identification, slot number identification, reset control, etc. The first column of rows 1-9 are designated as the control blocks 730. These blocks contain control signals such as flow control, start of cell indication, row validity information, etc. Finally, columns 1-6 of rows 1-9 are designated as the payload blocks 740. These blocks contain the primary traffic messages between the transmitter and receivers.

Although the above referenced data frame structure configuration is disclosed as being seven columns wide by ten rows tall for a total of 70 bytes of information, it should be understood that one of ordinary skill in the art will readily recognize that a variety of data frame structure configurations could be utilized while remaining within the spirit and scope of the present invention.

Data is sent from left-to-right, top-to-bottom starting from the top-left. The transmitter sends each block serially starting with the leftmost bit. At the receiver, the serial bit stream is recovered and the blocks are reconstructed. As a result, the control blocks 730 are effectively interleaved with the payload blocks 740. This minimizes the delay of the control data and allows for flexible payload boundaries.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

What is claimed:

1. A method for controlling the flow of data in a base transceiver station comprising:
a) providing first and second upstream devices;
b) providing a downstream device; and
c) enabling simultaneous communication between the downstream device and the first and second upstream devices.

2. The method of claim 1 wherein the first and second upstream devices each comprise a base transceiver station manager.

3. The method of claim 2 wherein the downstream device comprises multiple independent downstream devices.

4. The method of claim 3 wherein each downstream device comprises a channel module.

5. The method of claim 3 wherein the first and second base transceiver station managers include redundancy capabilities.

6. The method of claim 4 wherein the channel module comprises a backplane interface wherein the backplane interface is independently coupled to each base transceiver station manager.

7. The method of claim 6 wherein the backplane interface transmits and receives data to and from the first and second base transceiver station managers simultaneously via independent data paths.

8. The method of claim 7 wherein the backplane interface comprises a clock reference selection circuit and a data path multiplexor.

9. The method of claim 8 wherein the clock reference selection circuit is utilized to immediately switch to the first or second base transceiver station manager upon detection of a failure of the first or second base transceiver station manager.

10. The method of claim 8 wherein the backplane interface further comprises a data path de-multiplexor.

11. The method of claim 7 wherein the data comprises a data frame structure.

12. The method of claim 11 wherein the data frame structure comprises a frame sync portion, a provisioning information portion, a control portion and a payload portion.

13. The method of claim 12 wherein the data frame structure is in a table format.

14. The method of claim 13 wherein the table format comprises seven columns and ten rows.

15. A wireless communication system comprising:
at least one subscriber unit; and
at least one base transceiver station, the base transceiver station transmitting and receiving signals to and from the at least one subscriber unit, the at least one base transceiver station comprising:
a first upstream device;
a second upstream device coupled to the first upstream device; and
a downstream device coupled to the first and second upstream devices wherein the downstream device comprises means for enabling simultaneous communication between the downstream device and the first and second upstream devices.

16. The system of claim 15 wherein the first and second upstream devices each comprise a base transceiver station manager.

17. The system of claim 16 wherein the downstream device comprises multiple independent downstream devices.

18. The system of claim 17 wherein each downstream device comprises a channel module.

19. The system of claim 18 wherein the first and second base transceiver station manager include redundancy capabilities.

20. The system of claim 18 wherein the channel module comprises a backplane interface wherein the backplane interface is independently coupled to each base transceiver station manager.

21. The system of claim 20 wherein the backplane interface comprises means for transmitting and receiving data to and from the first and second base transceiver station managers simultaneously via independent data paths.

22. The system of claim 21 wherein the means for receiving data is coupled to a clock reference selection circuit and a data path multiplexor.

23. The system of claim 22 wherein the clock reference selection circuit is utilized to immediately switch to the first or second base transceiver station manager upon detection of a failure of the first or second base transceiver station manager.

24. The system of claim 22 wherein the means for transmitting data is coupled to a data path de-multiplexor.

25. The system of claim 21 wherein the data comprises a data frame structure.

26. The system of claim 25 wherein the data frame structure comprises a frame sync portion, a provisioning information portion, a control portion and a payload portion.

27. The system of claim 26 wherein the data frame structure is in a table format.

28. The system of claim 27 wherein the table format comprises seven columns and ten rows.

29. A base transceiver station for use in a wireless communication system including:
a first upstream device;
a second upstream device coupled to the first upstream device; and
a downstream device coupled to the first and second upstream devices wherein the downstream device comprises means for enabling simultaneous communication between the downstream device and the first and second upstream devices.

30. The base transceiver station of claim 29 wherein the first and second upstream devices each comprise a base transceiver station manager.

31. The base transceiver station of claim 30 wherein the downstream device comprises multiple independent downstream devices.

32. The base transceiver station of claim 31 wherein each downstream device comprises a channel module.

33. The base transceiver station of claim 32 wherein the first and second base transceiver station manager include redundancy capabilities.

34. The base transceiver station of claim 32 wherein the channel module comprises a backplane interface wherein the backplane interface is independently coupled to each base transceiver station manager.

35. The base transceiver station of claim 34 wherein the backplane interface comprises means for transmitting and receiving data to and from the first and second base transceiver station managers simultaneously via independent data paths.

36. The base transceiver station of claim 35 wherein the means for receiving data is coupled to a clock reference selection circuit and a data path multiplexor.

37. The base transceiver station of claim 36 wherein the clock reference selection circuit is utilized to immediately switch to the first or second base transceiver station manager upon detection of a failure of the first or second base transceiver station manager.

38. The base transceiver station of claim 36 wherein the means for transmitting data is coupled to a data path de-multiplexor.

39. The base transceiver station of claim 34 wherein the data comprises a data frame structure.

40. The base transceiver station of claim 39 wherein the data frame structure comprises a frame sync portion, a provisioning information portion, a control portion and a payload portion.

41. The base transceiver station of claim 40 wherein the data frame structure is in a table format.

42. The base transceiver station of claim 41 wherein the table format comprises seven columns and ten rows.

43. A data frame structure for use in a wireless communication system, the wireless communication system including a first upstream device, a second upstream device and a downstream device, the data frame structure comprising:
a frame sync portion;
a provisioning information portion;
a control portion; and
a payload portion wherein the data frame structure facilitates a simultaneous bi-directional flow of data between the downstream device and the first and second upstream devices.

44. The data frame structure of claim 43 wherein the data frame structure is in a table format.

45. The data frame structure of claim 44 wherein the table format comprises seven columns and ten rows.
